(19) United States
(12) Patent Application Publication
(10) Pub. No.: US 2011/0166930 A1
(43) Pub. Date: Jul. 7, 2011

(54) Computer System, Methods, Computer Models, and Computer Software for Enhancing a Customer List for a Targeted Marketing Campaign

(75) Inventors: Allen R. DeCotiis, Rhinebeck, NY (US); Martha M. Rea, Lutz, FL (US)

(73) Assignee: Phoenix Marketing International, Rhinebeck, NY (US)

(21) Appl. No.: 13/010,459

(22) Filed: Jan. 20, 2011

Related U.S. Application Data
(63) Continuation of application No. 11/222,987, filed on Sep. 9, 2005, now abandoned.
Application No. 11/222,987 is a continuation of application No. 09/815,985, filed on Mar. 22, 2001, now abandoned.
Application No. 09/815,985 is a continuation of application No. 09/816,813, filed on Mar. 22, 2001, now abandoned.
Application No. 09/816,813 is a continuation of application No. 09/815,545, filed on Mar. 22, 2001, now abandoned.
Application No. 09/815,545 is a continuation of application No. 09/816,794, filed on Mar. 22, 2001, now abandoned.

(51) Int. Cl. G06Q 30/00

(52) U.S. Cl. 705/14.52; 705/1.1

(57) ABSTRACT

Various computer systems, methods, computer models, and computer software are provided for enhancing a customer list for a targeted marketing campaign. One embodiment is a computer system comprising: a data storage device comprising: a customer list comprising customer information for a plurality of customers; and a survey results database for storing the results of a survey of each of the plurality of customers; a predictive computer model which models a relationship between the customer information and the results of the survey; and a scoring algorithm configured to generate a score for each of the plurality of customers based on the predictive computer model.

### CROSS-REFERENCE TO RELATED APPLICATIONS

This application is a continuation application of each of the following U.S. applications, each of which are hereby incorporated by reference in their entirety: U.S. application Ser. No. 11/222,987, filed on Sep. 9, 2005, and entitled “Computer Systems, Methods, Computer Models, And Computer Software For Enhancing a Customer List For a Targeted Marketing Campaign”; U.S. application Ser. No. 09/815,985, filed on Mar. 22, 2001, and entitled “System, Method and Article of Manufacture for a Weighted Model to Conduct Propensity Studies”; U.S. application Ser. No. 09/816,813, filed on Mar. 22, 2001, and entitled “System, Method and Article of Manufacture for Propensity-Based Scoring of Individuals”; U.S. application Ser. No. 09/815,545, filed on Mar. 22, 2001, and entitled “System, Method and Article of Manufacture for Generating a Model to Analyze a Propensity of an Individual to Have a Particular Attitude, Behavior, or Demographic”; and U.S. application Ser. No. 09/816,794, filed on Mar. 22, 2001, and entitled “System, Method and Article of Manufacture for Generating a Model to Analyze a Propensity of Customers to Purchase Products and Services”.

### BACKGROUND

Mass mailings of promotional offers are a common technique for luring potential customers into a business. From pizza restaurants to dentists, businesses inundate people with “junk” mail in an effort to induce patronage. Because most of these mailings are blind, a positive response rate of as little as 2 to 3% is considered successful. Some businesses, such as car repair, more effectively target potential repeat customers because they have a list of customers' names, addresses and nature of work performed. But even these businesses have little information about a customer's preferences. And other businesses such as restaurants and retail stores often do not even have a list of their customers' names. For these businesses, mass mailings may rarely justify the cost.

Thus, in mail marketing the most important factor is the quality of the business's mail list. Ideally, a mail list should include satisfied customers and information about their likes and dislikes so that promotions can be carefully tailored to the right customers. Such tailoring means fewer mailings and lower cost. The savings can be used for sending first class invitations rather than third class postcards; and such personal invitations may be more likely to be opened, read and considered positively.

Therefore, there is a need in the art for computer systems, methods, computer models, and computer software for providing an effective way for businesses to gather and compile information on their customers for tailored promotional mailings.

This information may then be used by the business for tailoring its promotional mailings, such as birthday offers, food specials, etc.

### SUMMARY

Various computer systems, methods, computer models, and computer software are provided for enhancing a customer list for a targeted marketing campaign. One embodiment is a computer system comprising: a data storage device comprising: a customer list comprising customer information for a plurality of customers; and a survey results database for storing the results of a survey of each of the plurality of customers; a predictive computer model which models a relationship between the customer information and the results of the survey; and a scoring algorithm configured to generate a score for each of the plurality of customers based on the predictive computer model.

Another embodiment is a method for generating an enhanced customer list for a targeted marketing campaign. One such method comprises: receiving a customer list comprising customer information for a plurality of customers; surveying each of the plurality of customers based on a market survey to determine survey results; modeling a relationship between the customer information and the survey results; and generating a score for each of the plurality of customers based on the predictive computer model.

A further embodiment comprises a computer system for providing a customer list enhancement service to a plurality of clients via a communications network. One such computer system comprises: a controller for interfacing with a communications network, the controller configured to: receive a customer list from a client via the communications network, the customer list comprising customer information for a plurality of customers; and administer a survey to each of the plurality of customers via the communications network; a predictive computer model which models a relationship between the customer information and results of the survey; and a scoring algorithm configured to generate a score for each of the plurality of customers based on the predictive computer model.

### BRIEF DESCRIPTION OF THE DRAWINGS

FIG. 1 illustrates a method for ranking individuals based on a propensity to have a particular attitude, behavior or demographic;

FIG. 2 shows a computer system in which the method of FIG. 1 may be implemented;

FIG. 2A illustrates a method for providing a computer model indicating a propensity of an individual to have a particular attitude, behavior or demographic;

FIG. 2B illustrates a method for providing a computer model indicating a propensity of a customer to purchase goods or services;

FIG. 2C illustrates a method for using a weighted computer model to conduct a propensity study, in accordance with FIGS. 2A and 2B;

FIG. 3 is a schematic illustration of a client database of the workstation of FIG. 2;

FIG. 4 is a schematic illustration of a survey database of the workstation of FIG. 2;

FIG. 5 is a flow chart illustrating a method for conducting a survey on behalf of a client;

FIG. 6 is a schematic illustration of a customer account database of the workstation of Figure;

FIGS. 7A and 7B are a flow chart illustrating a method for directing a respondent that is participating in a survey;

FIG. 8 is a schematic illustration of a certification question database of the workstation of FIG. 2;

FIG. 9 is a schematic illustration of the survey database and the certification question database of FIGS. 4 and 8, respectively;

FIG. 10 is a flow chart illustrating a method for interacting with a respondent in conducting a survey;

FIG. 11A is a now chart illustrating a first method for applying an inconsistency test to responses;

FIG. 11B is a flow chart illustrating a second method for applying an inconsistency test to responses;

FIG. 12 is a flow chart illustrating a third method for applying an inconsistency test to responses;

FIGS. 13A and 13B are a flow chart illustrating a fourth method for applying an inconsistency test to responses;

FIG. 14 is a flow chart illustrating a fifth method for applying an inconsistency test to responses;

FIG. 15 is a flow chart illustrating a method for creating a set of respondent questions from the survey questions of a plurality of surveys;

FIG. 16 is a schematic illustration of a response database of the workstation of FIG. 2;

FIG. 17 is a schematic illustration of a survey results database of the workstation of FIG. 2; and

FIG. 18 is a schematic illustration of another embodiment of the survey database of the workstation of FIG. 2.

### DETAILED DESCRIPTION

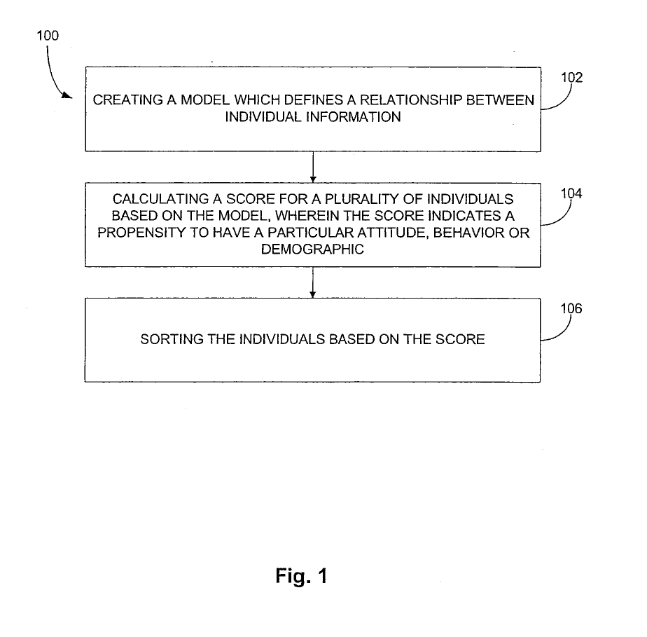

FIG. 1 illustrates a method 100 for ranking individuals based on a propensity to have a particular attitude, behavior or demographic. A survey is first conducted to determine consumer propensity to have a particular characteristic such as purchase intent for a product. Names are given by respondents or given using panel research methodologies.

Then, a model is created in operation 102 which defines a relationship between individual information. In one embodiment, the individual information may include information on a purchase intent for a particular product. Further, the information may be received utilizing a network, such as the Internet. As an option, the model may set forth a plurality of characteristics and a weight of each of the characteristics in calculating the score.

Next, in operation 104, a score is calculated for a plurality of individuals on a list based on the model. Such score indicates a propensity to have a particular attitude, behavior or demographic. Further, the individuals may be sorted or ranked on the list based on the score. See operation 106.

In one embodiment of the present invention, responses to the survey are matched on a case-by-case basis and models are created using the survey responses (buying propensity) as a dependent variable and internal list information as the “predictor” variables. As an option, a name, address and/or other types of information may be utilized in this process. The resultant predictive equation is then used to score the entire list for the propensity characteristic.

In another embodiment of the present invention, the model may be created using individual information including information stored in a customer database to derive the predictive equation once the score data has been matched to the list. Such individual information may include credit card information.

The purpose of the foregoing process is to score customer and consumer prospect lists with consumer attitudes and current propensity to buy particular services based on survey research. The present invention employs statistical algorithms derived from the information on the internal list to directly correlate survey research data with internal behavioral data in order to score the entirety of the list.

Glossary

The following terms may be used in describing the process of the present invention:

Algorithm: A mathematical formula which represents the specific numerical contributions of various characteristics to a specific behavior, attitude, demographic or propensity to purchase attribute.

Client: The purchaser of a model, file scoring or direct marketing consulting product/service.

Coding: The placement of a score or other information on an individual name on a customer/non-customer list.

Customer: The buyer of a good or service from a particular client.

Direct Marketing: The term used to describe the process by which organizations develop products/services for specific target groups and identify those groups in the population and, ultimately target them for the purchase of the good and/or service.

Mail Lists: Includes customer and non-customer lists of individuals or households from which organizations can score, code and target direct marketing efforts.

Panel Research Methodologies: This refers to services offered by companies such as NFO Worldwide, Market Facts and NPD who recruit large groups of households in different countries and maintain their names addresses and attitudinal and behavioral data on each household. These households can be sampled for research purposes and weighted to be representative of the population. The names can also be anonymously matched with customer and non-customer mailing lists with the data available on these lists appended to the survey research data.

Predictive Model: The mathematical formula which represents the best “predictive equation” of a particular behavior, attitude, demographic or purchase intent.

Record: A set of information representing all information on each individual or household for analytic purposes.

Sample: A subset of a customer base or population representative of the entire population.

Scoring: A numerical indicator of a specific attribute which is appended to a customer and/or non-customer file/list indicating the probability of a characteristic.

Segmentation: The process by which consumers are placed in homogeneous groups based on similarities of behavior, attitudes and/or demographics. All members of a particular group are then treated the same in the direct marketing process.

Weight: The relative contribution of individual characteristics to an overall predictive model.

System Architecture

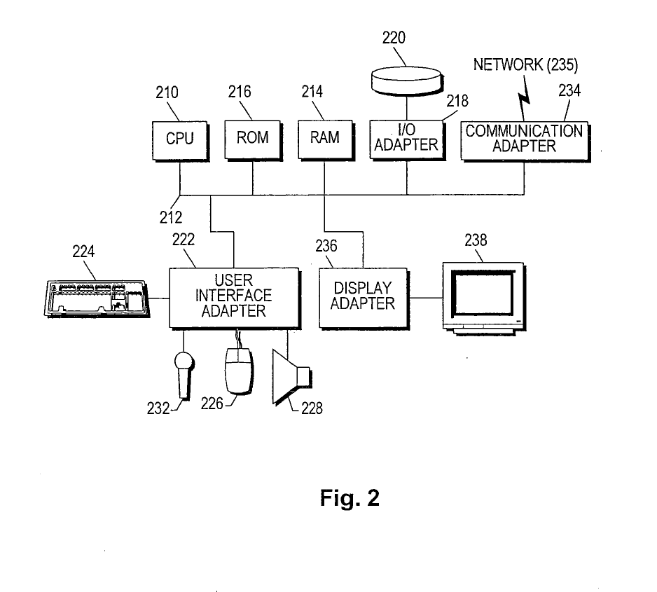

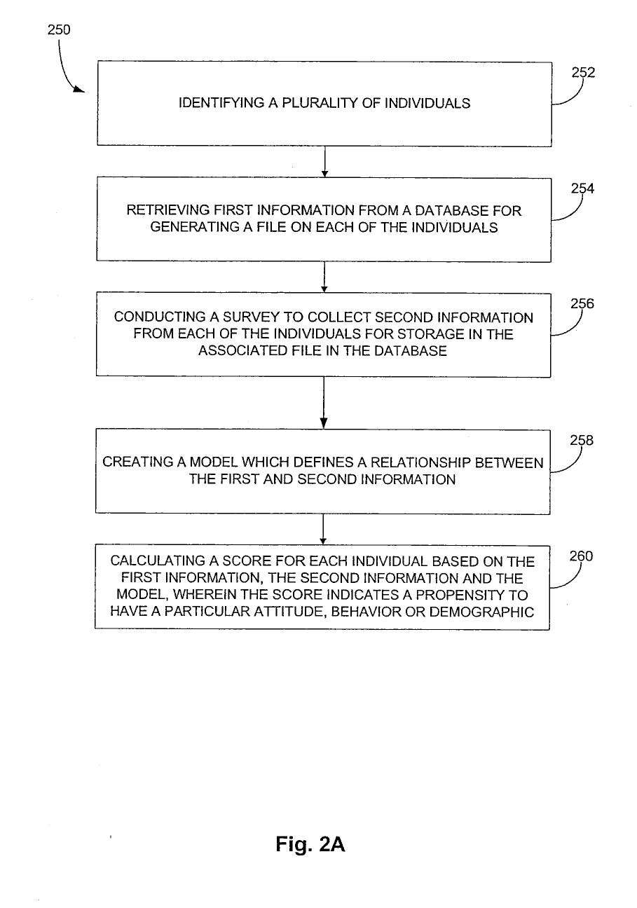

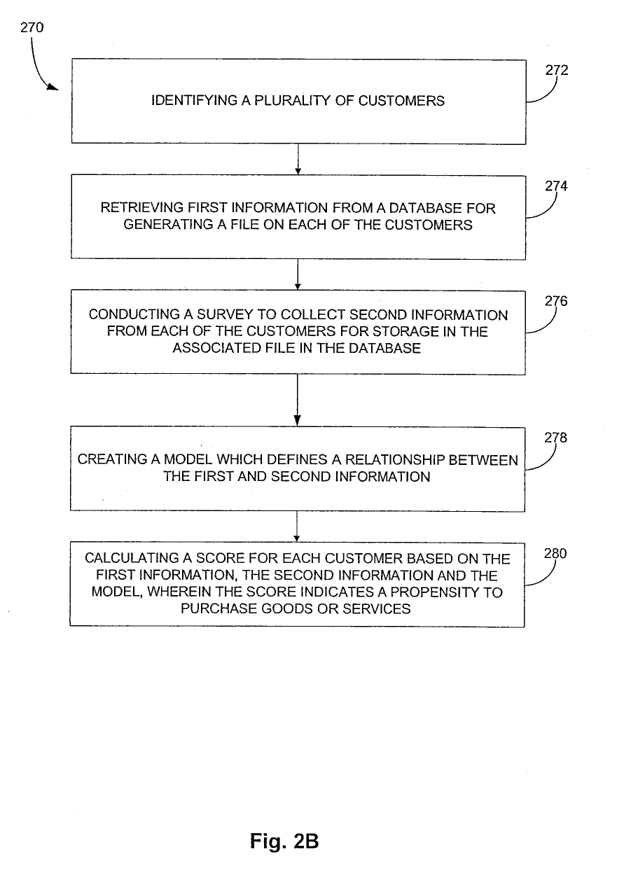

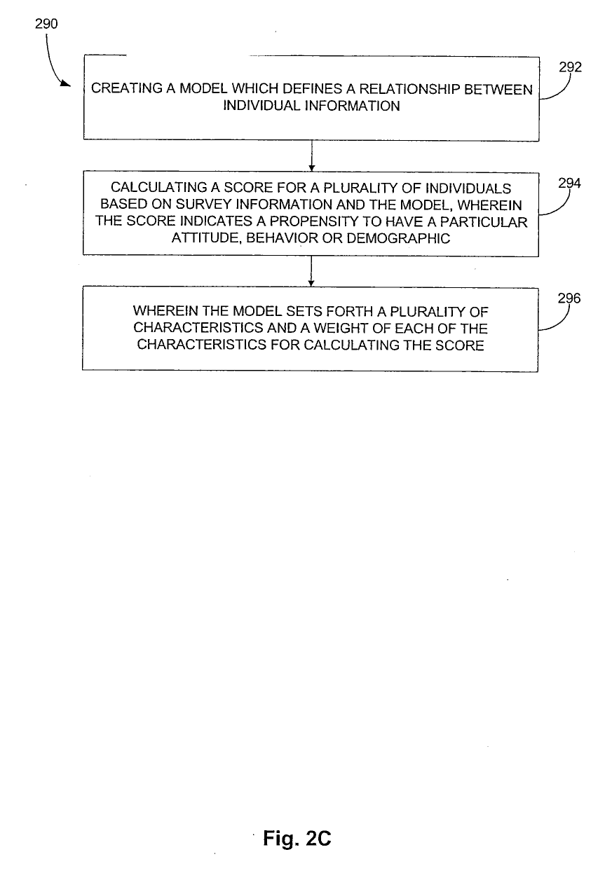

FIG. 2 shows a representative computer system in which the method 100 of FIG. 1 may be implemented. Such figure illustrates a typical hardware configuration of a workstation in accordance with a preferred embodiment having a central processing unit 210, such as a microprocessor, and a number of other units interconnected via a system bus 212.

The workstation shown in FIG. 2 includes a Random Access Memory (RAM) 214, such as disk storage units 220 to the bus 212, a user interface adapter 222 for connecting a keyboard 224, a mouse 226, a speaker 228, a microphone 232, and/or other user interface devices such as a touch screen (not shown) to the bus 212, communication adapter 234 for connecting the workstation to a communication network 235 (e.g., a data processing network) and a display adapter 236 for connecting the bus 212 to a display device 238.

The workstation typically has resident thereon an operating system such as the Microsoft Windows NT or Windows/95 Operating System (OS), the IBM OS/2 operating system, the MAC OS, or UNIX operating system. Those skilled in the art may appreciate that the present invention may also be implemented on platforms and operating systems other than those mentioned.

A preferred embodiment is written using JAVA, C, and the C++ language and utilizes object oriented programming methodology. Object oriented programming (OOP) has become increasingly used to develop complex applications. As OOP moves toward the mainstream of software design and development, various software solutions require adaptation to make use of the benefits of OOP. A need exists for these principles of OOP to be applied to a messaging interface of an electronic messaging system such that a set of OOP classes and objects for the messaging interface can be provided.

OOP is a process of developing computer software using objects, including the steps of analyzing the problem, designing the system, and constructing the program. An object is a software package that contains both data and a collection of related structures and procedures. Since it contains both data and a collection of strictures and procedures, it can be visualized as a self-sufficient component that does not require other additional structures, procedures or data to perform its specific task. OOP, therefore, views a computer program as a collection of largely autonomous components, called objects, each of which is responsible for a specific task. This concept of packaging data, structures, and procedures together in one component or module is called encapsulation.

In general, OOP components are reusable software modules which present an interface that conforms to an object model and which are accessed at run-time through a component integration architecture. A component integration architecture is a set of architecture mechanisms which allow software modules in different process spaces to utilize each others capabilities or functions. This is generally done by assuming a common component object model on which to build the architecture. It is worthwhile to differentiate between an object and a class of objects at this point. An object is a single instance of the class of objects, which is often just called a class. A class of objects can be viewed as a blueprint, from which many objects can be formed.

OOP allows the programmer to create an object that is a part of another object. For example, the object representing a piston engine is said to have a composition-relationship with the object representing a piston. In reality, a piston engine comprises a piston, valves and many other components; the fact that a piston is an element of a piston engine can be logically and semantically represented in OOP by two objects.

OOP also allows creation of an object that “depends from” another object. If there are two objects, one representing a piston engine and the other representing a piston engine wherein the piston is made of ceramic, then the relationship between the two objects is not that of composition. A ceramic piston engine does not make up a piston engine. Rather it is merely one kind of piston engine that has one more limitation than the piston engine; its piston is made of ceramic. In this case, the object representing the ceramic piston engine is called a derived object, and it inherits all of the aspects of the object representing the piston engine and adds further limitation or detail to it. The object representing the ceramic piston engine “depends from” the object representing the piston engine. The relationship between these objects is called inheritance.

When the object or class representing the ceramic piston engine inherits all of the aspects of the objects representing the piston engine, it inherits the thermal characteristics a standard piston defined in the piston engine class. However, the ceramic piston engine overrides these ceramic specific thermal characteristics, which are typically different from those associated with a metal piston. It skips over the original and uses new functions related to ceramic pistons. Different kinds of piston engines have different characteristics, but may have the same underlying functions associated with it (e.g., how many pistons in the engine, ignition sequences, lubrication, etc.). To access each of these functions in any piston engine object, a programmer would call the same functions with the same names, but each type of piston engine may have different/overriding implementations of functions behind the same name. This ability to hide different implementations of a function behind the same name is called polymorphism and it greatly simplifies communication among objects.

With the concepts of composition-relationship, encapsulation, inheritance and polymorphism, an object can represent just about anything in the real world. In fact, one's logical perception of the reality is the only limit on determining the kinds of things that can become objects in object-oriented software. Some typical categories are as follows:
Objects can represent physical objects, such as automobiles in a traffic-flow simulation, electrical components in a circuit-design program, countries in an economics model, or aircraft in an air-traffic-control system.
Objects can represent elements of the computer-user environment such as windows, menus or graphics objects.
An object can represent an inventory, such as a personnel file or a table of the latitudes and longitudes of cities.
An object can represent user-defined data types such as time, angles, and complex numbers, or points on the plane.

With this enormous capability of an object to represent just about any logically separable matters, OOP allows the software developer to design and implement a computer program that is a model of some aspects of reality, whether that reality is a physical entity, a process, a system, or a composition of matter. Since the object can represent anything, the software developer can create an object which can be used as a component in a larger software project in the future.

If 90% of a new OOP software program consists of proven, existing components made from preexisting reusable objects, then only the remaining 10% of the new software project has to be written and tested from scratch. Since 90% already came from an inventory of extensively tested reusable objects, the potential domain from which an error could originate is 10% of the program. As a result, OOP enables software developers to build objects out of other, previously built objects.

This process closely resembles complex machinery being built out of assemblies and sub-assemblies. OOP technology, therefore, makes software engineering more like hardware engineering in that software is built from existing components, which are available to the developer as objects. All this adds up to an improved quality of the software as well as an increased speed of its development.

Programming languages are beginning to fully support the OOP principles, such as encapsulation, inheritance, polymorphism, and composition-relationship. With the advent of the C++ language, many commercial software developers have embraced OOP. C++ is an OOP language that offers a fast, machine-executable code. Furthermore, C++ is suitable for both commercial-application and systems-programming projects. For now, C++ appears to be the most popular choice among many OOP programmers, but there is a host of other OOP languages, such as Smalltalk, Common Lisp Object System (CLOS), and Eiffel. Additionally, OOP capabilities are being added to more traditional popular computer programming languages such as Pascal.

The benefits of object classes can be summarized, as follows:
Objects and their corresponding classes break down complex programming problems into many smaller, simpler problems.
Encapsulation enforces data abstraction through the organization of data into small, independent objects that can communicate with each other. Encapsulation protects the data in an object from accidental damage, but allows other objects to interact with that data by calling the object's member functions and structures.
Subclassing and inheritance make it possible to extend and modify objects through deriving new kinds of objects from the standard classes available in the system. Thus, new capabilities are created without having to start from scratch.
Polymorphism and multiple inheritance make it possible for different programmers to mix and match characteristics of many different classes and create specialized objects that can still work with related objects in predictable ways.
Class hierarchies and containment hierarchies provide a flexible mechanism for modeling real-world objects and the relationships among them.
Libraries of reusable classes are useful in many situations, but they also have some limitations. For example:
Complexity. In a complex system, the class hierarchies for related classes can become extremely confusing, with many dozens or even hundreds of classes.
Flow of control. A program written with the aid of class libraries is still responsible for the flow of control (i.e., it may control the interactions among all the objects created from a particular library). The programmer has to decide which functions to call at what times for which kinds of objects.
Duplication of effort. Although class libraries allow programmers to use and reuse many small pieces of code, each programmer puts those pieces together in a different way. Two different programmers can use the same set of class libraries to write two programs that do exactly the same thing but whose internal structure (i.e., design) may be quite different, depending on hundreds of small decisions each programmer makes along the way. Inevitably, similar pieces of code end up doing similar things in slightly different ways and do not work as well together as they should.

Class libraries are very flexible. As programs grow more complex, more programmers are forced to reinvent basic solutions to basic problems over and over again. A relatively new extension of the class library concept is to have a framework of class libraries. This framework is more complex and consists of significant collections of collaborating classes that capture both the small scale patterns and major mechanisms that implement the common requirements and design in a specific application domain. They were first developed to free application programmers from the chores involved in displaying menus, windows, dialog boxes, and other standard user interface elements for personal computers.

Frameworks also represent a change in the way programmers think about the interaction between the code they write and code written by others. In the early days of procedural programming, the programmer called libraries provided by the operating system to perform certain tasks, but basically the program executed down the page from start to finish, and the programmer was solely responsible for the flow of control. This was appropriate for printing out paychecks, calculating a mathematical table, or solving other problems with a program that executed in just one way.

The development of graphical user interfaces began to turn this procedural programming arrangement inside out. These interfaces allow the user, rather than program logic, to drive the program and decide when certain actions should be performed. Today, most personal computer software accomplishes this by means of an event loop which monitors the mouse, keyboard, and other sources of external events and calls the appropriate parts of the programmer's code according to actions that the user performs. The programmer no longer determines the order in which events occur. Instead, a program is divided into separate pieces that are called at unpredictable times and in an unpredictable order. By relinquishing control in this way to users, the developer creates a program that is much easier to use. Nevertheless, individual pieces of the program written by the developer still call libraries provided by the operating system to accomplish certain tasks, and the programmer may still determine the flow of control within each piece after it's called by the event loop. Application code still “sits on top of” the system.

Even event loop programs require programmers to write a lot of code that should not need to be written separately for every application. The concept of an application framework carries the event loop concept further. Instead of dealing with all the nuts and bolts of constructing basic menus, windows, and dialog boxes and then making these things all work together, programmers using application frameworks start with working application code and basic user interface elements in place. Subsequently, they build from there by replacing some of the generic capabilities of the framework with the specific capabilities of the intended application.

Application frameworks reduce the total amount of code that a programmer has to write from scratch. However, because the framework is really a generic application that displays windows, supports copy and paste, and so on, the programmer can also relinquish control to a greater degree than event loop programs permit. The framework code takes care of almost all event handling and flow of control, and the programmer's code is called only when the framework needs it (e.g., to create or manipulate a proprietary data structure).

A programmer writing a framework program not only relinquishes control to the user (as is also true for event loop programs), but also relinquishes the detailed flow of control within the program to the framework. This approach allows the creation of more complex systems that work together in interesting ways, as opposed to isolated programs, having custom code, being created over and over again for similar problems.

Thus, as is explained above, a framework basically is a collection of cooperating classes that make up a reusable design solution for a given problem domain. It typically includes objects that provide default behavior (e.g., for menus and windows), and programmers use it by inheriting some of that default behavior and overriding other behavior so that the framework calls application code at the appropriate times.

There are three main differences between frameworks and class libraries:
Behavior versus protocol. Class libraries are essentially collections of behaviors that one can call when he or she want those individual behaviors in a program. A framework, on the other hand, provides not only behavior but also the protocol or set of rules that govern the ways in which behaviors can be combined, including rules for what a programmer is supposed to provide versus what the framework provides.
Call versus override. With a class library, the code the programmer instantiates objects and calls their member functions. It's possible to instantiate and call objects in the same way with a framework (i.e., to treat the framework as a class library), but to take full advantage of a framework's reusable design, a programmer typically writes code that overrides and is called by the framework. The framework manages the flow of control among its objects. Writing a program involves dividing responsibilities among the various pieces of software that are called by the framework rather than specifying how the different pieces should work together.
Implementation versus design. With class libraries, programmers reuse only implementations, whereas with frameworks, they reuse design. A framework embodies the way a family of related programs or pieces of software work. It represents a generic design solution that can be adapted to a variety of specific problems in a given domain. For example, a single framework can embody the way a user interface works, even though two different user interfaces created with the same framework might solve quite different interface problems.

Thus, through the development of frameworks for solutions to various problems and programming tasks, significant reductions in the design and development effort for software can be achieved. A preferred embodiment of the invention utilizes HyperText Markup Language (HTML) to implement documents on the Internet together with a general-purpose secure communication protocol for a transport medium between the client and the Newco. HTTP or other protocols could be readily substituted for HTML without undue experimentation. Information on these products is available in T. Berners-Lee, D. Connoly, “RFC 1866: Hypertext Markup Language—2.0” (November 1995); and R. Fielding, H, Frystyk, T. Berners-Lee, J. Gettys and J. C. Mogul, “Hypertext Transfer Protocol—HTTP/1.1: HTTP Working Group Internet Draft” (May 2, 1996). HTML is a simple data format used to create hypertext documents that are portable from one platform to another. HTML documents are SGML documents with generic semantics that are appropriate for representing information from a wide range of domains. HTML has been in use by the World-Wide Web global information initiative since 1990. HTML is an application of ISO Standard 8879; 1986 Information Processing Text and Office Systems; Standard Generalized Markup Language (SGML).

To date, Web development tools have been limited in their ability to create dynamic Web applications which span from client to server and interoperate with existing computing resources. Until recently, HTML has been the dominant technology used in development of Web-based solutions. However, HTML has proven to be inadequate in the following areas:
Poor performance;
Restricted user interface capabilities;
Can only produce static Web pages;
Lack of interoperability with existing applications and data; and
Inability to scale.
Sun Microsystem's Java language solves many of the client-side problems by:
Improving performance on the client side;
Enabling the creation of dynamic, real-time Web applications; and
Providing the ability to create a wide variety of user interface components.

With Java, developers can create robust User Interface (UI) components. Custom “widgets” (e.g., real-time stock tickers, animated icons, etc.) can be created, and client-side performance is improved. Unlike HTML, Java supports the notion of client-side validation, offloading appropriate processing onto the client for improved performance. Dynamic, real-time Web pages can be created. Using the above-mentioned custom UI components, dynamic Web pages can also be created.

Sun's Java language has emerged as an industry-recognized language for “programming the Internet.” Sun defines Java as: “a simple, object-oriented, distributed, interpreted, robust, secure, architecture-neutral, portable, high-performance, multithreaded, dynamic, buzzword-compliant, general-purpose programming language. Java supports programming for the Internet in the form of platform-independent Java applets.” Java applets are small, specialized applications that comply with Sun's Java Application Programming Interface (API) allowing developers to add “interactive content” to Web documents (e.g., simple animations, page adornments, basic games, etc.). Applets execute within a Java-compatible browser (e.g., Netscape Navigator) by copying code from the server to client. From a language standpoint, Java's core feature set is based on C. Sun's Java literature states that Java is basically, “C++ with extensions from Objective C for more dynamic method resolution.”

Another technology that provides similar function to JAVA is provided by Microsoft and ActiveX Technologies, to give developers and Web designers wherewithal to build dynamic content for the Internet and personal computers. ActiveX includes tools for developing animation, 3-D virtual reality, video and other multimedia content. The tools use Internet standards, work on multiple platforms, and are being supported by over 100 companies. The group's building blocks are called ActiveX Controls, small, fast components that enable developers to embed parts of software in hypertext markup language (HTML) pages. ActiveX Controls work with a variety of programming languages including Microsoft Visual C++, Borland Delphi, Microsoft Visual Basic programming system and, in the future, Microsoft's development tool for Java, code named “Jakarta.” ActiveX Technologies also includes ActiveX Server Framework, allowing developers to create server applications. One of ordinary skill in the art readily recognizes that ActiveX could be substituted for JAVA without undue experimentation to practice the invention.

Non-Customer Model

FIG. 2A illustrates a method 250 for providing a model indicating a propensity of an individual to have a particular attitude, behavior or demographic. Initially, in operation 252, a plurality of individuals are identified, i.e. a sample, either from an external list using panel research methodologies, or from an internal customer list. Thereafter, first information is retrieved for generating a file, or record, on each of the individuals. See operation 254. Optionally, the first information may include information relating to the internal/external list. A survey is then conducted to collect second information from each of the individuals for storage in the associated file in the database, as indicated in operation 256. The second information may include information on a purchase intent for a particular product.

The survey data may then be matched and merged on a case by case basis either to the external or internal list utilizing a name, address or other identifying characteristic.

A model is then created in operation 258 which defines a relationship between the first and second information. The model may also set forth a plurality of characteristics and a weight of each of the characteristics for calculating the score.

Such score is subsequently calculated for each individual based on the external/internal list, and the model. Such score indicates a propensity to have a particular attitude, behavior or demographic. Note operation 260. As an option, an equation may be created based on the first information, the second information and the model, wherein the equation is used to calculate the score. Further, the individuals may be sorted based on the score.

As such, a sample of customers is created and surveyed as to their propensity to have a particular attitude, behavior and/or demographic. After the survey is conducted, internal behavioral and demographic information may be appended to the records of each respondent from the client internal data file (e.g., a credit card customer file).

For example, the survey may ask the potential purchase intent for a particular product. Additional questions are posed which may be related to this behavior such as demographic, attitudinal, or behavioral information. When the survey is completed, records are obtained reflecting the survey information and the information from the customer file on individual or households actual behaviors (for example, use of credit cards.)

Further, the individuals may be grouped into households. For privacy purposes, an identity of a head individual of the household may be maintained confidential. The name of the household or individual is thus masked, and ultimately, removed to assure confidentiality.

Using multivariate statistical techniques, a model is then created to include the characteristics and magnitudes of characteristics that “best” predict the purchase intent from the survey instrument data. This becomes the predictive model of behavior complete with an overall predictive score of the likely behavior and the “weights” of each contributing characteristic to this score.

Next, the model is recreated using the behavioral and demographic information from the customer file. The predictive model uses only the information on the customer file and defines the specific predictive characteristics and weights of each to predicting a particular attitude, behavior and/or demographic. The output of this model is an equation which is then applied to the customer file to give each customer a “score” for their likelihood of having the particular attitude, behavior and/or demographic. The equation is then calculated for each individual or household on the list and the result represents a predictive score for each record.

When the client then wishes to undertake a direct marketing campaign, they sort their customers by the highest scores of having likelihood to buy the product/service and offer the product only to those individuals/households. The result is lower marketing costs and higher purchase rates among those who receive the offer.

Customer Model

FIG. 2B illustrates a method 270 for providing a model indicating a propensity of a customer to purchase goods or services. Initially, in operation 272, a plurality of customers are identified.

Thereafter, in operation 274, first information is retrieved from a database for generating a file, or record, on each of the customers. As an option, the first information may include credit card use information and/or any other information relating to an external/internal list. A survey is subsequently conducted to collect second information from each of the customers for storage in the associated file in the database. Note operation 276. Moreover, the second information may include information on a purchase intent for a particular product.

A model may then be created which defines a relationship between the first information, and the second information, as indicated in operation 278. In one embodiment of the present invention, the model sets forth a plurality of characteristics and a weight of each of the characteristics for calculating the score.

A score may then be calculated in operation 280 for each customer based on the first information, the second information, and the model. Such scores indicate a propensity of the customers to purchase goods or services. As an option, an equation may be generated based on the first information, the second information and the model, wherein the equation is used to calculate the score. In one embodiment of the present invention, the customers may be sorted and then ranked based on the score.

In other words, a sample of individuals or households representing the potential groups being targeted is developed. A questionnaire is then created to determine their propensity to have a particular attitude, behavior and/or demographic. Any additional attitude, behavior or demographic information available on the list is appended to each record.

For example, the survey may ask the potential purchase intent for a particular product. Additional questions are posed which may be related to this behavior such as demographic, attitudinal, or behavioral information. When the survey is completed, records are obtained reflecting the survey information and the information from the customer file on individual or households actual behaviors (for example, use of credit cards.) The name of the household or individual is masked, and, ultimately, removed to assure confidentiality.

Using multivariate statistical techniques, a model is then created to include the characteristics and magnitudes of characteristics that “best” predict the purchase intent from the survey instrument data. This becomes the predictive model of behavior complete with an overall predictive score of the likely behavior and the “weights” of each contributing characteristic to this score.

Next, the model is recreated using the behavioral and demographic information from the enhanced list. The predictive model uses only the information on the enhanced list and defines the specific predictive characteristics and weights of each to predicting a particular attitude, behavior and/or demographic. The output of this model is an equation which is then applied to the list to give each customer a “score” for their likelihood of having the particular attitude, behavior and/or demographic. The equation is then calculated for each individual or household on the list and the result represents a predictive score for each record.

When the client then wishes to undertake a direct marketing campaign, they sort their list by the highest scores of having likelihood to buy the product/service and offer the product only to those individuals/households. The result is lower marketing costs and higher purchase rates among those who receive the offer.

Unique aspects of this process include: the matching of customer information with research information, the development of transfer algorithms to score the internal data tiles with the customer research/attitudinal information, and the scoring process using this algorithm.

For example, a sample of bank credit card customers may be drawn using panel research methodologies which have already surveyed and collected name, address, credit card ownership information as well as other characteristics. The survey may ask consumers about their interest in a new credit card product on a scale of 1 to 5 (for example), where 5 is very likely. As an option, such survey may be web-based.

The survey data may subsequently be key punched into a database. Further, a list of names, addresses and other identifying information is developed with an identification code on such list and the survey database.

The bank may then match the name and addresses from the survey data and an internal database to create a tile including all of the customer information (credit card transactions, etc.). Such file is appended to the name, address and identification code list. Name and addresses are then deleted for privacy purposes. This may also be accomplished by the bank providing the necessary information to a panel research company.

The panel research company then combines the databases on a case by case basis. Using multivariate statistical techniques, a predictive model is created to predict likely purchase of a new card product using the survey data as the dependent variable and internal customer information as the predictive variable.

The result is a predictive equation that is then used to score and rank the entire bank customer list for propensity to buy the new card product.

Appropriate responders to the new product may then be “marketed to.” Of course, a similar example may be inferred regarding a non-customer model where the bank becomes the external list company.

FIG. 2C illustrates a method 290 for using a weighted model to conduct a propensity study, in accordance with the methods set forth in FIGS. 2A and 2B. The method 290 is for creating a weighted propensity to have a characteristic such as purchase intent utilizing survey research data combined with either external or internal list information.

Initially, a model is created in operation 292. A score is then calculated for a plurality of individuals based on the survey information and the model. Note operation 294. Such score indicates a propensity to have a particular attitude, behavior or demographic. Further, the model sets forth a plurality of characteristics and a weight of each of the characteristics for calculating the score. See operation 296.

In one embodiment of the present invention, responses to a survey are matched on a case-by-case basis and models are created using the survey responses (buying propensity) as a dependent variable and internal list information as the “predictor” variables. The resultant predictive equation is then used to score the entire list for the propensity characteristic.

Further, the individuals on the list are sorted based on the score. As an option, the individuals may be sorted on the list by ranking the same.

In another embodiment of the present invention, the model may be created using individual information including information stored in a customer database to derive the predictive equation once the score data has been matched to the list. Such individual information may include credit card information.

Additional information regarding an exemplary technique for collecting survey information in accordance with operations 256 and 276 of FIGS. 2A and 2B, respectively, will now be set forth.

In the context of the present embodiment, the system of FIG. 2 may be referred to as a “controller” that is in communication with respondent devices for conducting a survey. Such respondent devices are typically computers or other devices for communicating over a computer network such as the Internet.

The controller may receive desired survey questions and survey parameters. The controller conducts the specified survey by transmitting the survey questions to respondents via respondent devices. In one embodiment, the controller may be a computer operated by an online service provider or an Internet service provider (ISP). Such a computer typically facilitates the connection of many computers to the Internet.

If desired, known cryptographic techniques may be used to authenticate the identity of parties transmitting messages in the present embodiment for conducting a survey. The use of cryptographic techniques can also serve to verify the integrity of the message, determining whether the message has been altered during transmission. Encryption can also prevent eavesdroppers from learning the contents of the message. Such techniques are referred to generally as cryptographic assurance methods, and include the use of both symmetric and asymmetric keys as well as digital signatures and hash algorithms. The practice of using cryptographic protocols to ensure the authenticity of the identities of parties transmitting messages as well as the integrity of messages is well known in the art and need not be described here in detail. Accordingly, one of ordinary skill in the art may refer to Bruce Schneier, Applied Cryptography, Protocols, Algorithms, And Source Code In C, (2d Ed, John Wiley & Sons, Inc., 1996). The use of various encryption techniques is described in the above-referenced parent application, as are other methods for ensuring the authenticity of the identities of parties transmitting messages. In addition, the present invention provides for the anonymity of both clients and respondents, as is also described in detail in the above-referenced parent application.

The storage device 220 of FIG. 2 may be equipped store (i) a client database, (ii) a survey database, (iii) a customer account database, (iv) a certification question database, (v) a response database, and (vi) a survey results database. The databases are described in detail below and depicted with exemplary entries in the accompanying figures. As will be understood by those skilled in the art, the schematic illustrations of and accompanying descriptions of the databases presented herein are exemplary arrangements for stored representations of information. A number of other arrangements may be employed besides those represented by the tables shown. Similarly, the illustrated entries represent exemplary information, but those skilled in the art will understand that the number and content of the entries can be different from those illustrated herein.

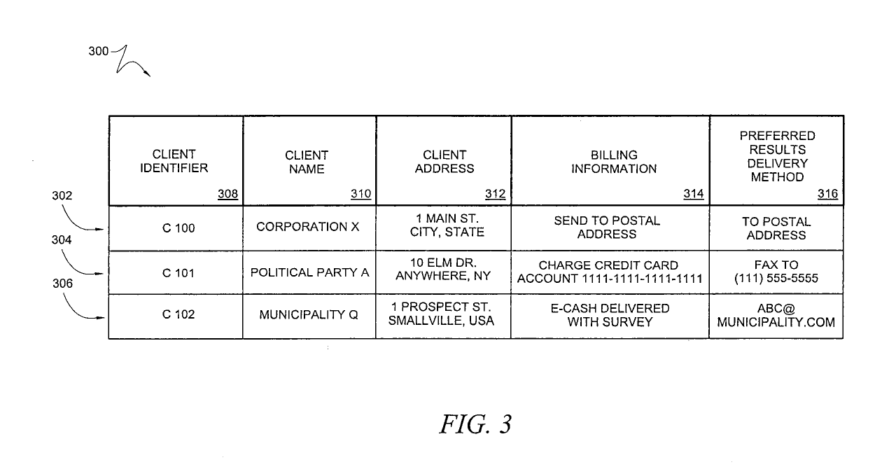

Referring to FIG. 3, a table 300 represents an embodiment of the client database of FIG. 2. The table 300 includes rows 302, 304 and 306, each of which represents an entry of the client database. Each entry defines a client, which is an entity that has the controller (FIG. 2) conduct surveys on its behalf. In particular, each entry includes (i) a client identifier 308 that uniquely identifies the client, (ii) a client name 310, (iii) a client address 312, (iv) billing information 314 that specifies how the client is to be charged for surveys conducted on its behalf, and (v) a preferred method of delivering survey results 316.

The data stored in the client database may be received from the controller (FIG. 2). For example, an entity may use the workstation to access a site on the World Wide Web (“Web”) where it registers to become a client. The appropriate data would be requested and entered via that site, communicated to the controller (FIG. 2), and stored in a newly-created entry of the client database.

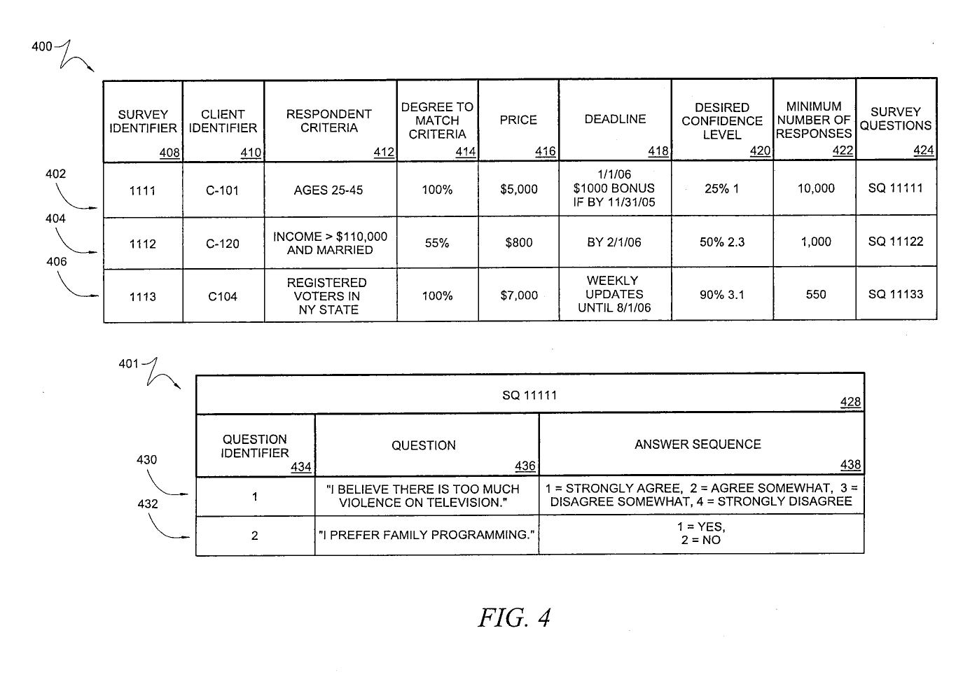

Referring to FIG. 4, tables 400 and 401 collectively represent an embodiment of the survey database in the memory 220 of FIG. 2. The table 400 includes rows 402, 404 and 406, each of which represents an entry that defines a survey that is to be conducted on behalf of a client. In particular, each entry includes (i) a survey identifier 408 for uniquely identifying the survey, (ii) a client identifier 410 for indicating the client on whose behalf the survey is conducted, (iii) respondent criteria 412 that specify the types of respondents whose responses are desired, (iv) a degree 414 to which the respondent must match the specified respondent criteria, (v) a price 416 paid by the client in return for having the survey conducted, (vi) a deadline 418 by which the responses to the survey must be assembled and provided to the client, (vii) a desired confidence level 420 of the survey results which includes a percentage and an offset, (ix) a minimum number of responses 422, and (x) an indication of the survey questions 424.

The desired confidence level includes a percentage that is the probability that the true average associated with a question is within a predefined interval. The interval is in turn defined as an interval from one offset less than the sample average (defined by the average of the received responses) to one offset greater than the sample average. For example, if a survey question is “What is the best age to start having children?”, then the sample average (based on the received responses) might be the age “27”. If the confidence level percentage is 95% and the offset is 1.0 years, then the desired confidence level is achieved if it is determined that the true average age has a 95% probability of being in the interval from “26” (27−1) to “28” (27+1). Calculating a confidence level is described in “Introduction to Statistics”, by Susan Wagner, published by Harper Perennial, 1992.

A table such as the table 401 would typically exist for each entry of the table 400. The table 401 includes an identifier 428 which corresponds to an indication of the survey questions of the table 400 and which uniquely identifies the survey questions represented thereby. The table 401 also includes rows 430 and 432, each of which defines a survey question. In particular, each entry includes (i) a question identifier 434 that uniquely identifies the survey question of the table 401; (ii) a question description 436, which may be in the form of text, graphical image, audio or a combination thereof; and (iii) an answer sequence 438 defining possible responses which the respondent may select, and an order of those responses. In certain embodiments of the present invention, the survey question may not have an answer sequence, but may instead allow the respondent to provide a “free form” response comprising, for example, text he types or audio input he speaks. For example, for a survey question “What is your favorite name for a boy?” the respondent may be allowed to type his favorite name in his response.

As illustrated above, the respondent criteria specify the types of respondents whose responses to the survey questions are desired. In another embodiment, each survey question may include associated respondent criteria. Thus, different questions of a survey could be targeted to differed types of respondents. Similarly, each survey question may also specify a deadline, a desired confidence level, and/or a minimum number of responses.

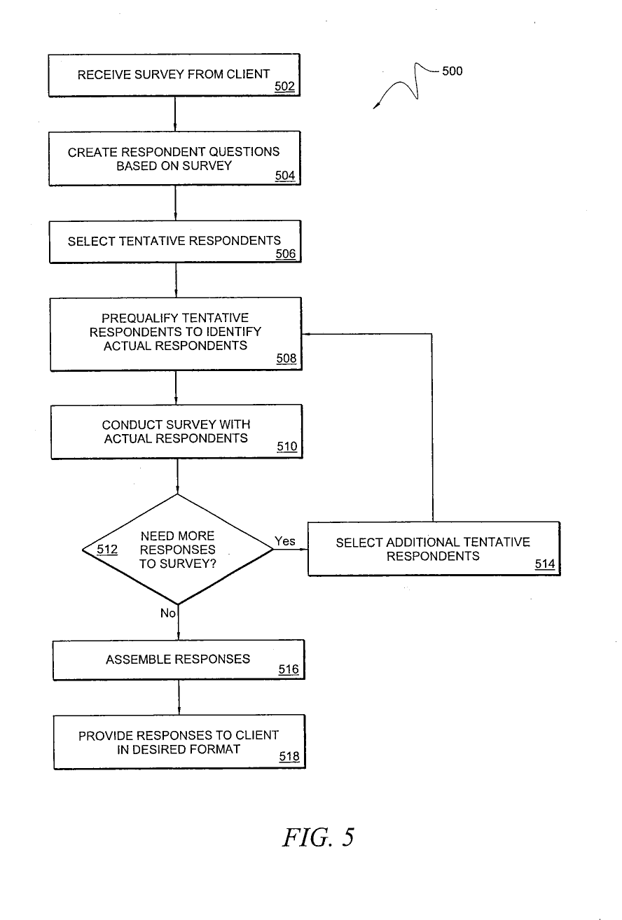

Referring to FIG. 5, a method 500 is performed by the controller (FIG. 2) for conducting a survey on behalf of a client. The controller receives a survey from the client (step 502). The survey includes survey questions as well as other data such as respondent criteria, indicated above with respect to FIG. 4. The survey may be received from a computer accessing a site on the Web. The appropriate data would be requested and entered via that site and communicated to the controller (FIG. 2).

Alternatively, the survey may be entered into the controller via an input device in communication therewith, as will be understood by those skilled in the art. The controller creates respondent questions based on the survey questions (step 504), as is described in detail below. Tentative respondents are selected (step 506). Although the tentative respondents may meet the respondent criteria, it can be desirable to assure further that the respondents meet other criteria. For example, a respondent profile may only include data volunteered by each respondent with no assurance that the data is accurate. Accordingly, the tentative respondents are prequalified (step 508) in order to identify actual respondents that will participate in the survey.

Prequalifying the tentative respondents may include transmitting qualification questions to each tentative respondent. The qualification questions may define, for example, a test of English language competency or a test for familiarity with luxury vehicles. Responses to the qualification questions are received, and a qualification test is applied to the responses to generate a qualification test result. Based on the qualification test result a set of actual respondents is selected (e.g. respondents with at least a particular level of English language competency).

The survey is then conducted with the actual respondents (step 510) in a manner described in detail below. If still more responses are required (step 512), as may be true to satisfy a minimum number of respondents or a desired confidence level, then additional tentative respondents are selected (step 514). It may also be necessary to select additional tentative respondents if the previous respondents do not represent an accurate sampling of a desired population. It may also be necessary to select additional tentative respondents based on responses received. For example, a majority of Connecticut respondents may provide a certain response, so additional respondents from New England are desired. Additional tentative respondents may also be selected if a desired set of responses is not achieved. For example, a client may require that at least 80% of respondents provide the same response. If there is no such majority response, additional respondents are desired. If no more responses are required, then the responses are assembled (step 516) and provided to the client in a desired format (step 518).

Respondent questions may be transmitted via electronic mail to an electronic mail address corresponding to the respondent. Such transmission does not require the respondent to be logged on when the respondent question is transmitted. Alternatively, the controller may transmit a program to a respondent device and direct the respondent device to run the program. The program may be, for example, a lava applet or application program that presents the respondent questions to the respondent, receives the corresponding responses and transmits the responses to the controller.

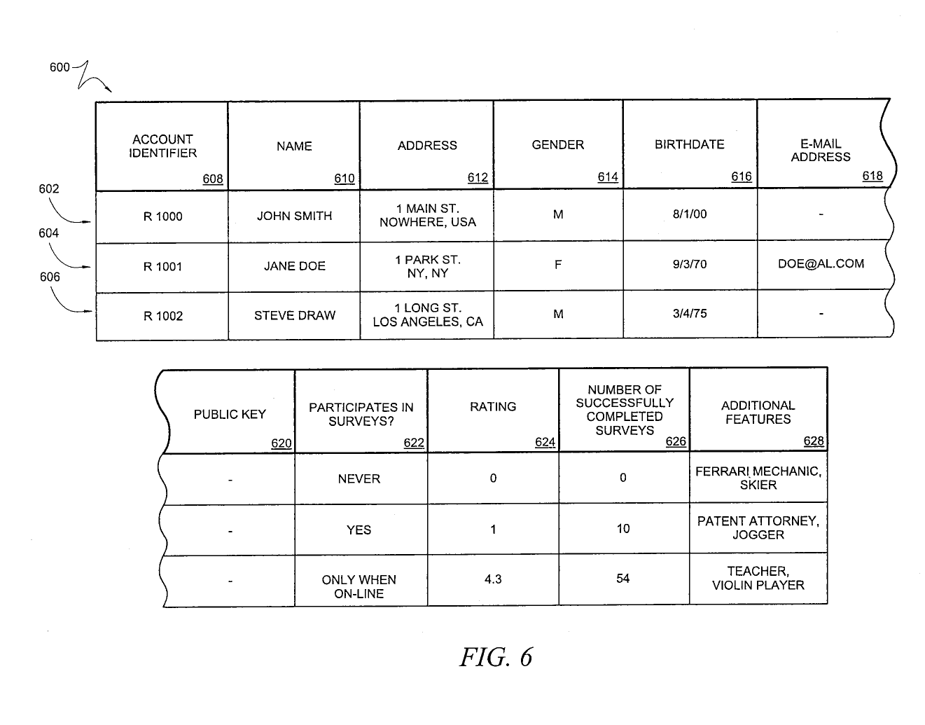

Referring to FIG. 6, a table 600 represents an embodiment of the customer account database of FIG. 2. The table 600 includes rows 602, 604 and 606, each of which represents an entry of the customer account database. Each entry defines a customer profile of a party having an account, such as an account with an online service provider. Those skilled in the art will understand that in other embodiments the entries of the customer account database may define parties having other types of accounts, such as bank accounts or casino-based frequent player accounts. Some customers represented by the customer account database may be solicited to participate in surveys, and thereby become respondents

Each entry includes (i) an account identifier 608 that uniquely identifies the customer, (ii) a customer name 610, (iii) a customer address 612, (iv) the gender 614 of the customer, (v) the birth date 616 of the customer, (vi) an electronic mail address 618 of the customer, (vii) a public key 620 of the customer for use in cryptographic applications, (viii) an indication of whether the customer is willing to participate in surveys 622, (ix) a rating 624 that is based on past survey participation of the customer, (x) the number of successfully completed surveys 626, and (xi) additional features 628 of the customer profile. Those skilled in the art will understand that many different types of information may be stored for each customer profile.

The data stored in the customer account database may be received from the respondent devices. For example, an entity may use a respondent device to access a site on the Internet where it registers (e.g. to become a customer of an online service provider). The appropriate data would be requested and entered via that site, communicated to the controller (FIG. 2), and stored in a newly-created entry of the customer account database.

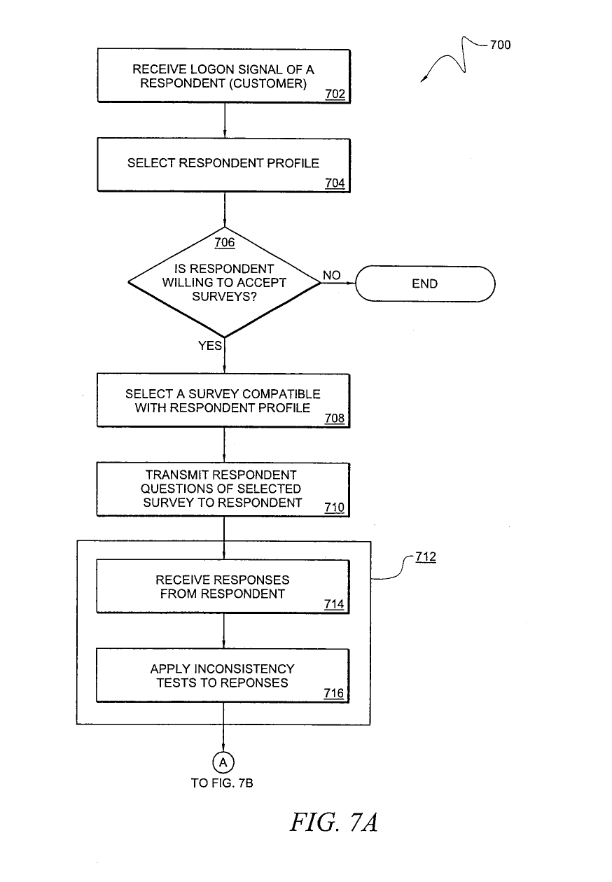

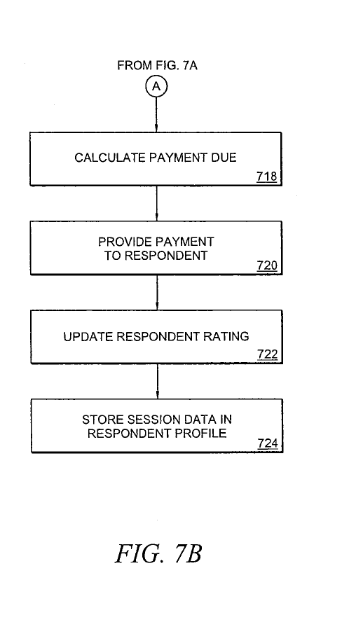

Referring to FIGS. 7A and 7B, a method 700 is performed by the controller (FIG. 2) in directing a respondent that is participating in a survey. The method 700 is primarily directed to a respondent that connects (“logs on”) to the controller or to another device in communication with the controller. For example, if the controller is operated by an online service provider, then the controller can identify each respondent device that begins a communication session therewith (e.g. to connect the respondent device to the Internet via the controller).

The controller receives a log-on signal (step 702) that indicates that a customer (a potential respondent) has logged on. In response, the controller selects the customer profile corresponding to the indicated customer (step 704). For example, the log-on signal may include an account identifier that indicates an entry of the customer account database of FIG. 2. The entry in turn defines a customer profile which serves as a respondent profile if the indicated customer chooses to become a respondent of a survey.

If the customer profile indicates that the customer is willing to participate in surveys (step 706), then the controller selects a survey that is compatible with the respondent profile (step 708). For example, a particular survey may be directed to parties between the ages of twenty-five and forty-five. This survey would be compatible if the corresponding birth date of the respondent profile indicates that the respondent is between the ages of twenty-five and forty-five. Alternatively, the customer may be allowed to select from a list of surveys in which he may participate (i.e. compatible surveys).

The respondent questions of the selected survey are transmitted to the respondent (step 710). As described in detail below, the respondent questions of a survey are based on (but may differ from) corresponding survey questions. Reference numeral 712 indicates steps in which data is received from the respondent. In general, the inconsistency tests to the responses (step 716). The steps 714 and 716 may be repeated, as necessary. Each of the steps 714 and 716 are described in further detail below.

In one embodiment the controller may transmit all respondent questions and then await responses thereto. In another embodiment the controller may transmit respondent questions one at a time and await a response thereto before transmitting the next respondent question. The latter-described embodiment is advantageous when certain respondent questions are to be only transmitted depending on the responses received to previous respondent questions. Accordingly, it will be understood by those skilled in the art that when reference is made to transmitting questions and receiving responses, either embodiment is acceptable.

After all responses have been received from the respondent, the controller calculates the payment due (step 718) and provides that payment to the respondent (step 720). The above-referenced parent application describes several methods for transferring payments. Those methods are applicable to the payment from client as well as payment to respondents. In addition, the respondent rating is updated (step 722) to reflect the responses received during the session, and other session data is stored in the corresponding respondent profile (step 724). For example, the respondent rating may be selected from a set of predefined ratings: “gold” if he answered more than fifty surveys successfully and without a fraud signal being generated, “normal” otherwise. Other types of ratings and rating criteria will be understood by those skilled in the art.

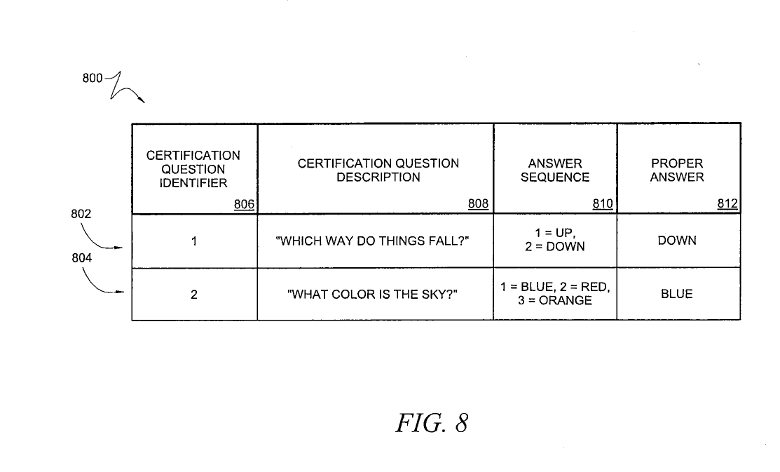

Referring to FIG. 8, a table 800 represents an embodiment of the certification question database. The certification question database includes entries 802 and 804, each of which defines a certification question (a question for determining whether a respondent is a computer, is not paying attention or otherwise may not provide responses that are useful to the client). The use of certification questions in surveys conducted via computer networks is advantageous because their use can help identify responses that originate from computers or humans not paying attention to the question. Without such questions, it would be difficult to determine whether received responses constituted useful data.

Each entry includes (i) a certification question identifier 806 that uniquely identifies the certification question, (ii) a certification question description 808 which may include text of the question, (iii) an answer sequence 810 that defines possible responses which the respondent may select and an order of those responses, and (iv) the proper answer 812 to the certification question.

The certification question database is updated periodically so that new certification questions are added. Older certification questions may also be deleted periodically if desired. Adding new certification questions makes it extremely difficult for an unscrupulous party to design a program that automatically provides the proper answers to certification questions. There can be certification questions which stay the same, but for which the proper response changes frequently (e.g. “what was the big new event today'?”). Certification questions need not be an interrogative but nonetheless invite a reply (e.g. “Answer (b) to this question”).

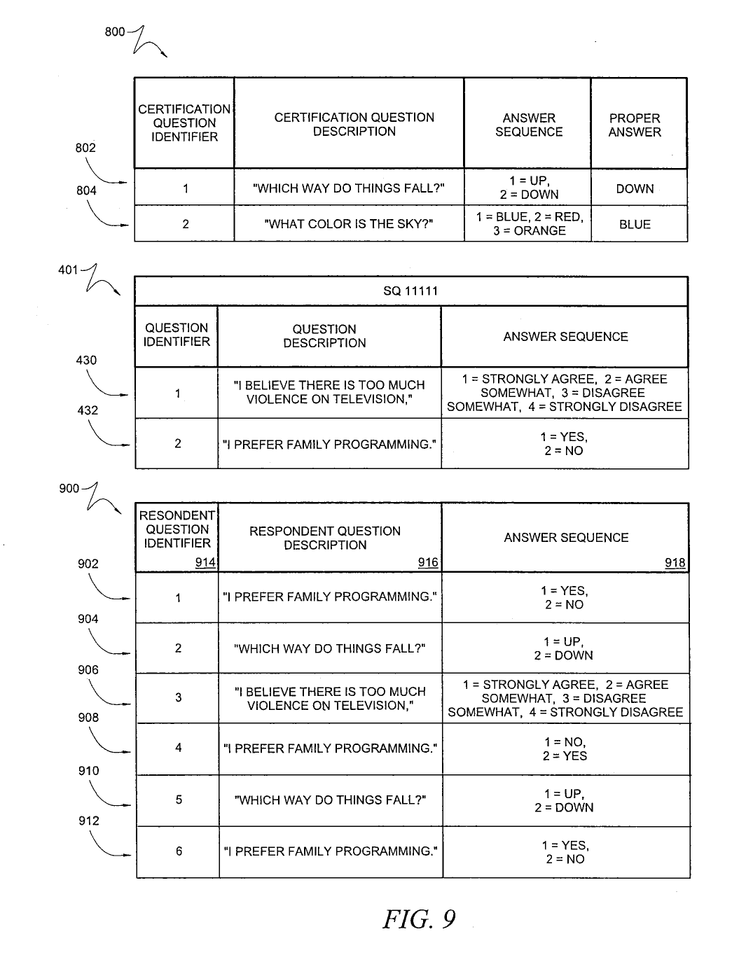

Referring to FIG. 9, the table 800 which defines certification questions and the table 401 which defines survey questions are illustrated again with an exemplary set of respondent questions generated therefrom. Each respondent question is created based on one or more survey questions, one or more certification questions, or a combination thereof.

A table 900 represents a plurality of respondent questions. The table 900 includes entries 902, 904, 906, 908, 910 and 912, each defining a respondent question. Each entry includes (i) a respondent question identifier 914 that uniquely identifies the respondent question, (ii) a respondent question description 916, and (iii) an answer sequence 918.

A plurality of respondent questions may be based on the same survey question or certification question. For example, the entries 904 and 910 represent respondent questions that are each based on the certification question represented by the entry 802. If a plurality of respondent questions are based on the same survey question or certification question, then the corresponding responses should match if the respondent is human and paying attention. As used herein, responses are deemed to match if they each define the same answer, even if the answer sequences of the corresponding questions are not identical. For example, if a first answer sequence is “l=yes, 2=no” and a second answer sequence is “1=no, 2=yes”, then the responses match if both responses are “no” (or if both responses are “yes”). In addition, if the respondent questions are based on a certification question, then the responses should also match the corresponding proper answer of the certification question. An inconsistency test would be applied to assure that the responses to certification-based questions match the corresponding proper answer of the certification question.

A respondent question may include an answer sequence that is identical to or different from the answer sequence of the survey question or certification question on which it is based. For example, the entry 902 represents a respondent question that is based on the survey question represented by the entry 432. The answer sequence defined by the entry 902 is identical to the answer sequence defined by the entry 432. Similarly, the entry 908 represents a respondent question that is also based on the survey question represented by the entry 432. However, the answer sequence defined by the entry 908 is different from the answer sequence defined by the entry 432. Thus, a respondent that provides random or otherwise meaningless responses will be unlikely to provide responses that are consistent. For example, if a respondent always selects the first response of the answer sequence, he cannot provide consistent responses to a plurality of respondent questions with different answer sequences.

As described below, a respondent question based on a certification question may be created and transmitted to a respondent along with respondent questions that are based on survey questions. In some embodiments it can be desirable to transmit such certification-based respondent questions only after receiving an indication (hereinafter a “warning sign”) that the responses may be from a computer or from a human that is not paying attention.

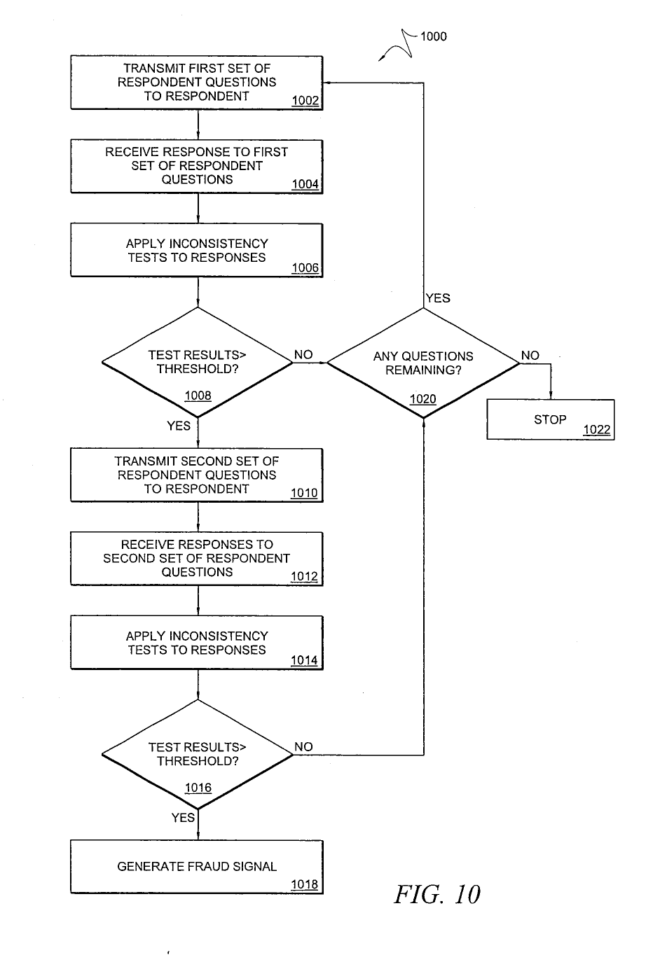

Referring to FIG. 10, a method 1000 is performed by the controller (FIG. 2) in transmitting respondent questions to a respondent and receiving responses to those respondent questions. The controller transmits a first set of respondent questions to the respondent (step 1002) and receives responses to the first set of respondent questions (step 1004). The controller applies an inconsistency test to the responses to generate an inconsistency test result (step 1006). Several types of inconsistency tests are described in detail below.

Based on the inconsistency test result, it is determined whether a warning sign is indicated (step 1008). For example, it may be determined whether the inconsistency test results are greater than a predetermined threshold. If so, then a second set of respondent questions are transmitted to the respondent (step 1010), and corresponding responses thereto are received (step 1012). The controller then applies an inconsistency test to these responses to generate another inconsistency test result (step 1014). If this inconsistency test result indicates a warning sign (step 1016), then a fraud signal is generated (step 1018). As described below, various actions may be performed upon generation of a fraud signal.

If both inconsistency test results do not indicate a warning sign, then it is determined whether there are any respondent questions remaining (step 1020). If so, then those respondent questions are transmitted to the respondent, as described above (step 1002). Otherwise, the controller stops transmitting respondent questions to the respondent (step 1022).

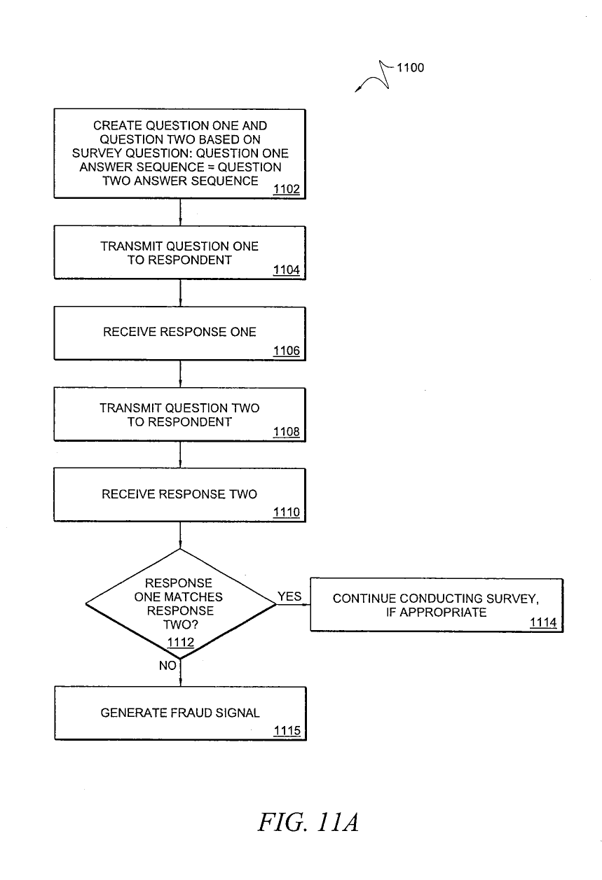

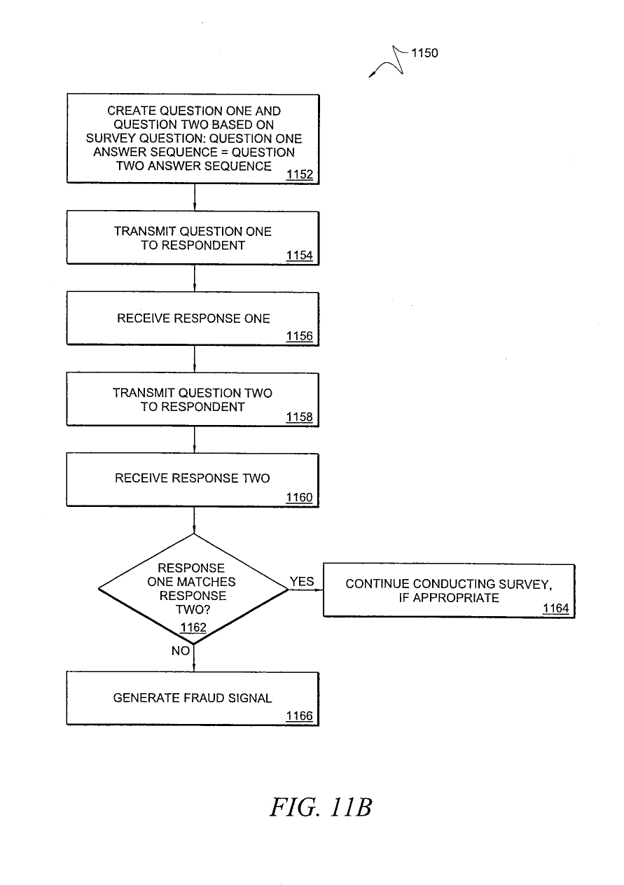

Referring to FIG. 11A, the controller (FIG. 2) may apply a first inconsistency test to responses by comparing the responses of identical respondent questions. At step 1102 of the method 1100, the controller creates a first question (“question one”) and a second question (“question two”) based on a single survey question. Question one and question two define the same answer sequence. Those skilled in the art will understand that question one and question two may instead be based on a certification question.

Question one is transmitted to the respondent (step 1104), and a corresponding response (“response one”) is received (step 1106). Similarly, question two is transmitted to the respondent (step 1108), and a corresponding response (“response two”) is received (step 1110). If response one matches response two (step 1112), then the controller continues conducting the survey, if appropriate (step 1114). Otherwise, a fraud signal is generated (step 1116).

Referring to FIG. 11B, the controller (FIG. 2) may apply a second inconsistency test to responses by comparing the responses to respondent questions that are based on the same survey question but that have different answer sequences. At step 1152 of the method 1150, the controller creates a first question (“question one”) and a second question (“question two”) based on a single survey question. Those skilled in the an will understand that question one and question two may instead be based on a certification question.

Question one is transmitted to the respondent (step 1154), and a corresponding response (“response one”) is received (step 1156). Similarly, question two is transmitted to the respondent (step 1158), and a corresponding response (“response two”) is received (step 1160). If response one matches response two (step 1162), then the controller continues conducting the survey, if appropriate (step 1164). Otherwise, a fraud signal is generated (step 1166).

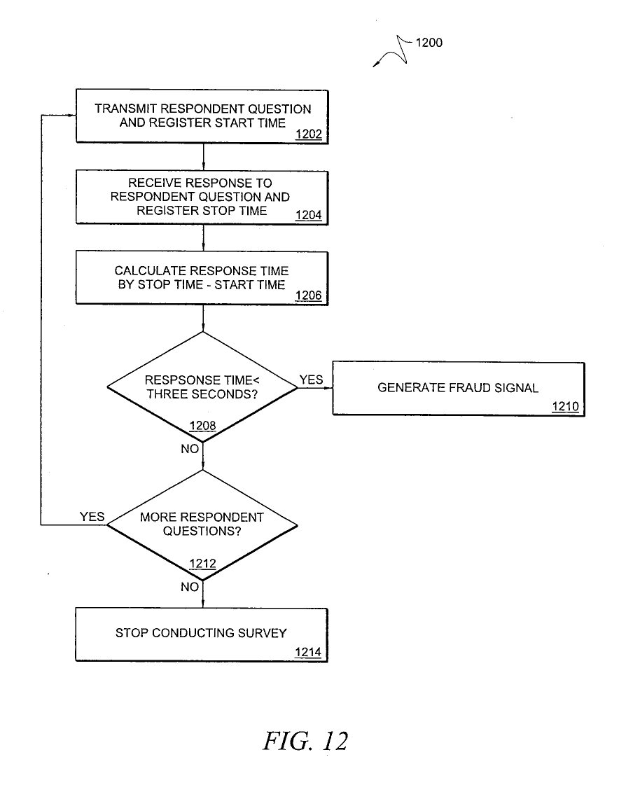

Referring to FIG. 12, a method 1200 is performed by the controller (FIG. 2) in applying a third inconsistency test to responses. In particular, the controller measures the time it takes a respondent to provide a response. If the response is provided too quickly, it likely indicates that the respondent has not read the question before responding or that the respondent is a computer.

The controller transmits a respondent question and registers the time thereof, called a “start time” (step 1202). Then, a response to the respondent question is received, and the time of receipt (“stop time”) is registered (step 1204). The response time of the respondent is calculated as the difference between the stop time and the start time (step 1206). If the response time is less than a predetermined threshold (step 1208), then a fraud signal is generated (step 1210). Although the predetermined threshold illustrated in FIG. 12 is the exemplary value “three seconds”, those skilled in the art will understand that other values may be used. Otherwise, it is determined whether there are more respondent questions (step 1212). If so, then the controller continues transmitting those respondent questions (step 1202). If not, then the controller stops conducting the survey with this respondent (step 1214).

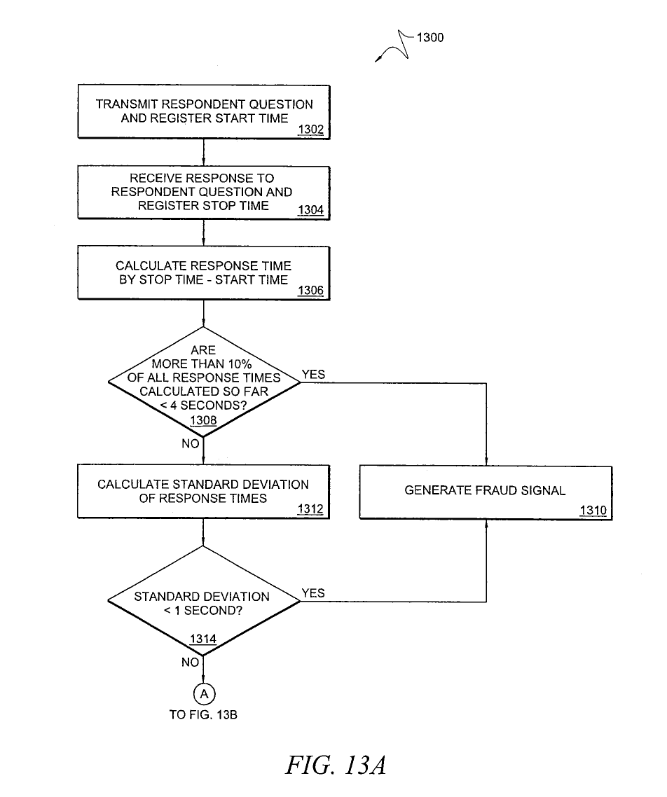

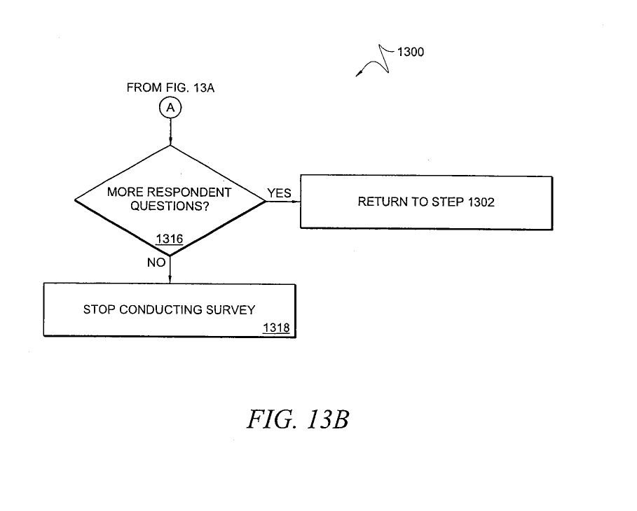

Referring to FIGS. 13A and 13B, a method 1300 is performed by the controller (FIG. 2) in applying a fourth inconsistency test to responses. In particular, the controller measures the time it takes a respondent to provide responses to a plurality of respondent questions. If the response time does not vary significantly, then it likely indicates that the respondent is a computer or a human that is not paying attention.

The controller transmits a respondent question and registers the start time (step 1302). Then, a response to the respondent question is received, and the stop time is registered (step 1304). The response time is calculated as the difference between the stop time and the start time (step 1306). If more than a predetermined percentage of the response times are less than a predetermined threshold (step 1308), then a fraud signal is generated (step 1310). Although in FIG. 13 exemplary values are illustrated for the predetermined percentage (10%) and the predetermined threshold (four seconds), those skilled in the art will understand that other values may be used as desired. Those skilled in the art will also understand that a respondent device, rather than the controller, may register the start time and stop time and calculate the response time.

Otherwise, the standard deviation of the response times is calculated (step 1312). If the standard deviation is below a predetermined threshold (step 1314), then a fraud signal is generated (step 1310). Otherwise, it is determined whether there are more respondent questions to be answered (step 1316). If so, those respondent questions are transmitted to the respondent (step 1302). If not, then the controller stops conducting the survey with this respondent (step 1318).

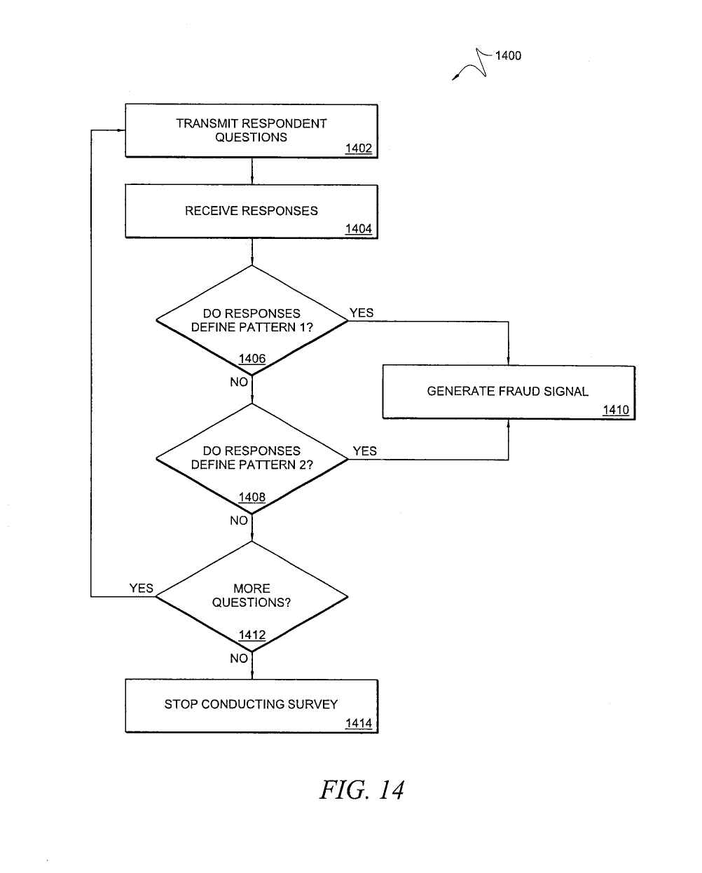

Referring to FIG. 14, a method 1400 is performed by the controller (FIG. 2) in applying a fifth inconsistency test to responses. In particular, the controller determines whether the responses define a predetermined pattern (e.g. all responses are the first response choice). If the responses define a predetermined pattern, then it likely indicates that the respondent is a computer or a human that is not paying attention.

The controller transmits respondent questions (step 1402), and receives responses thereto (step 1404). If the responses define a first pattern (step 1406) or define a second pattern (step 1408), then a fraud signal is generated (step 1410). The controller may test to see if the responses define any number of predetermined patterns. If there are more respondent questions (step 1412), then those respondent questions are transmitted to the respondent (step 1402). Otherwise, the controller stops conducting the survey with this respondent (step 1414).

When a fraud signal is generated, the controller may ignore the responses received from the corresponding respondent. In addition, if a fraud signal is generated, payment to the respondent may be reduced or eliminated, the respondent may be sent a message of reprimand, and/or the respondent may be barred from future participation in surveys. The rating of a respondent may likewise reflect the generation of a fraud signal. Similarly, the client may be informed that certain responses were accompanied by a fraud signal. The client may be offered a reduced price if he accepts these responses in the assembled survey results. In one embodiment, payment due to the respondent accrues until it is paid to the respondent at predetermined times (e.g. once per month). In this embodiment, the fraud signal can prevent accrued payment from being paid to the respondent. Generation of a fraud signal can thus prevent the respondent from receiving the payment from several surveys. Accordingly, the respondent has a strong incentive to avoid actions that may generate a fraud signal.

It can be further desirable to “mix” questions from a plurality of surveys and present those questions to a respondent. Thus, the respondent may participate in a plurality of surveys substantially simultaneously. This is advantageous in that it makes it more difficult to develop of program that can repeatedly respond to a single survey.

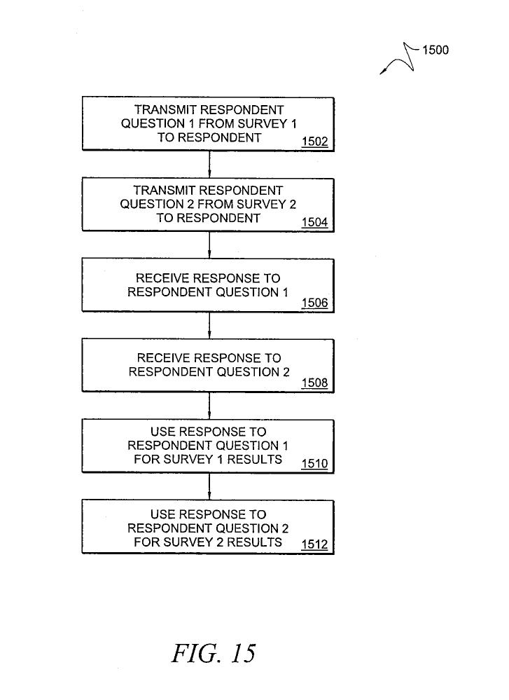

Referring to FIG. 15, a method 1500 is performed by the controller (FIG. 2) in directing a respondent to participate in more than one survey substantially simultaneously. In the flow chart of FIG. 15, a respondent may participate in two surveys. Of course, more than two surveys are possible as well. A plurality of surveys may be selected based on an amount of time. For example, the respondent may specify an amount of time he would like to spend answering questions. Based on the specified amount of time, one or more surveys are used in generating respondent questions for the respondent. Alternatively, the surveys may be selected based on, for example, surveys that must be conducted within the shortest amount of time.

The controller transmits to the respondent a first respondent question from a first survey (step 1502) and a second respondent question from a second survey (step 1504). The controller in him receives a response to the first respondent question (step 1506) and a response to the second respondent question (step 1508). The response to the first respondent question is used for the first survey (step 1510), and the response to the second respondent question is used for the second survey (step 1512). As described above, the actual order of transmitting respondent questions and receiving responses may vary. For example, both respondent questions may be transmitted before any responses are received. Alternatively, the second respondent question may not be transmitted until the first response is received.

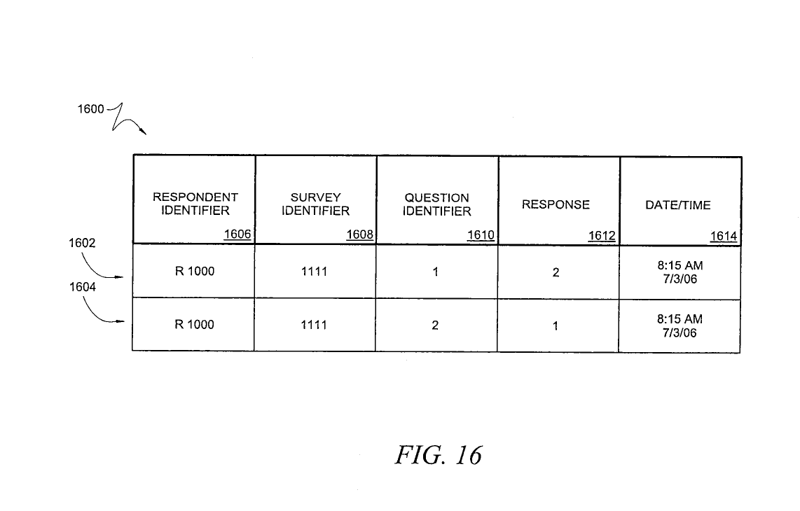

Referring to FIG. 16, a table 1600 represents an embodiment of the response database (FIG. 2). The responses received from respondents are stored in the response database, where they may be assembled, analyzed and otherwise utilized for clients. The received responses may be stored in the response database indefinitely. Alternatively, the received responses may be purged after a predetermined amount of time or when additional storage space is required.

The table 1600 includes entries 1602 and 1604, each defining a received response. In particular, each entry includes (i) a respondent identifier 1606 that identifies the respondent providing the response, and which corresponds to an account identifier of the customer account database (FIG. 2), (ii) a survey identifier 1608 that identities the survey and which corresponds to a survey identifier of he survey database, (iii) a question identifier 1610 that identifies the respondent question and that corresponds to a respondent question identifier as described above with reference to FIG. 9, (iv) a response 1612 received from the respondent, and (v) a date and time 1614 that the response was received.

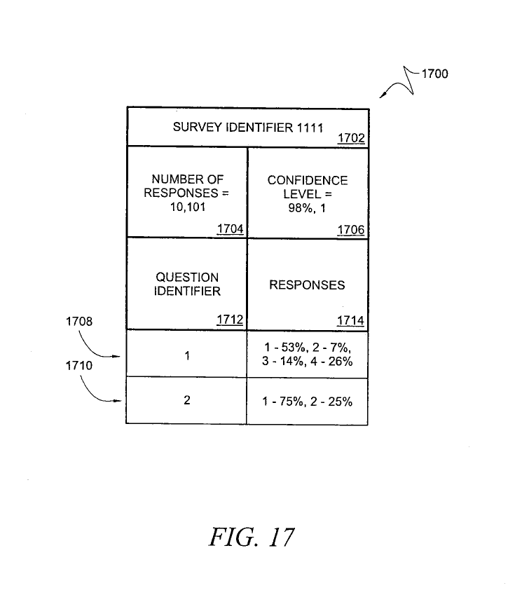

Referring to FIG. 17, a table 1700 represents a record of the survey results database (FIG. 2). The record is identified by a survey identifier 1702, which corresponds to a survey identifier of the survey database. The table also includes an indication of the number of responses received 1704 for this survey and an indication of the actual confidence level 1706 of the received responses. Calculating a confidence level based on a set of received responses is described in the above-cited book “Introduction to Statistics”.

The table 1700 also includes entries 1708 and 1710, each of which defines the results in summary form of the responses received for a survey question. Each entry includes (i) a question identifier 1712 that uniquely identifies the survey question, and which corresponds to a survey question identifier of the survey database (FIG. 2); and (ii) responses 1714 to the survey question in summary form. Many ways of summarizing the received responses will be understood by those skilled in the art. In addition, the client may specify a preferred format for the summary.

In one embodiment, each of a plurality of survey questions included in a survey may be assigned a priority. Such an embodiment allows a client to specify which types of information he is most interested in (i.e. subjects addressed by high priority survey questions).

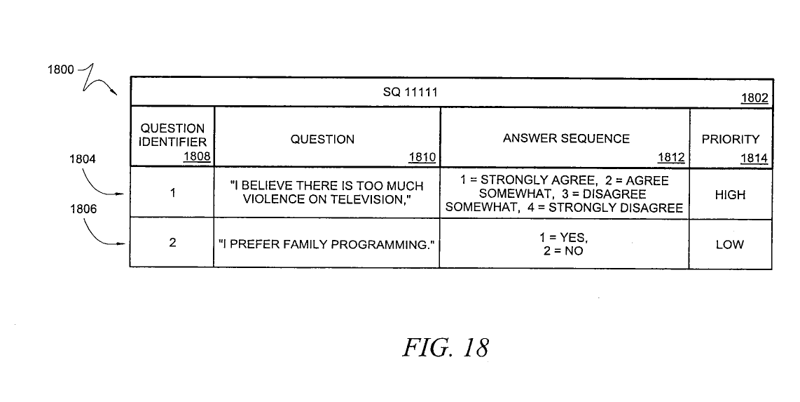

Referring to FIG. 18, a table 1800 represents another embodiment of the survey database of FIG. 2. A table such as the table 1800 would typically exist for each entry of the table 400 (FIG. 4). The table 1800 includes an identifier 1802 uniquely identifying the survey questions represented thereby. The table 1800 also includes rows 1804 and 1806, each of which defines a survey question. In particular, each entry includes (i) a question identifier 1808 that uniquely identifies the survey question of the table 1800; (ii) a question description 1810, which may be in the form of text, graphical image, audio or a combination thereof; (iii) an answer sequence 1812 defining possible responses which the respondent may select, and an order of those responses; and (iv) a priority 1814 of the survey question.

Higher priority survey questions may be sent to more respondents than lower priority questions. For example, high priority survey questions may be transmitted to respondents, and then depending on an amount of resources remaining (e.g. money to pay respondents), a selected set of the low priority survey questions may be transmitted to a smaller number of respondents. Accordingly, it is possible that some survey questions will never be transmitted to respondents. In another embodiment, lower priority survey questions are transmitted to respondents only after a desired confidence level is reached for higher priority survey questions.

Survey questions may also be variable in that they incorporate information such as responses to other survey questions or responses by other respondents to the same survey question. For example, if a large number of respondents indicate that the color “green” is the most preferred for a new car, then additional survey questions may be directed towards the color “green”. Accordingly, there may be a survey question (e.g. “Why do you like color [X]?”) and adjusted questions are created based on the fact that responses indicate the color “green” is most preferred. Subsequent survey questions may be based on the responses (e.g. “Do you prefer lime green or dark green?”).

In one embodiment of the present invention, the client may specify survey questions that include one or more question parameters. Corresponding respondent questions are created by a random or calculated selection of values for the question parameters. Subsequently-generated respondent questions may have values selected based on responses received for previously-generated respondent questions, in an effort to generate respondent questions that achieve a more favorable response. Accordingly, the creation of corresponding respondent questions from such survey questions is dynamic, and so these survey questions are referred to as “dynamic survey questions”. Dynamic survey questions are best employed when it is difficult or impossible to know in advance which respondent questions or which parameters of questions are most desirable. In addition, the dynamic nature of respondent question generation is based on human intervention—the participation of respondents.

For example, a dynamic survey question may comprise a logo having four parameters: a foreground color, a background color, a font size and a font type. Each parameter may assume a plurality of values. Respondent questions which define logos having specific colors, font sizes and font types are created and transmitted to respondents. Based on received responses (e.g. most respondents like red and blue, few like logos that have a certain font type), additional respondent questions are created and transmitted (e.g. logos that are red and blue, and that have a well-liked font).

Certain survey questions may define comparisons to be made, so the respondent would answer based on a comparison of two (or more) things. For example, the respondent may be asked to indicate which of two logos he prefers, which of four slogans he finds least annoying, or which of three sounds he thinks is the most attention-getting. Comparison is especially advantageous when it may be difficult for a respondent to provide an evaluation in absolute terms. For example, it may be difficult for a respondent to provide an absolute amount by which he prefers a certain logo, but he can more easily indicate which of two logos he prefers.

Similarly, once a response to a comparison is received, the respondent may be asked to compare similar things until his response changes. In one embodiment, one feature of an object to compare may be gradually altered until the respondent changes his response. For example, the respondent may indicate that he prefers a first logo to a second logo. Then, the font size of the first logo is increased until the respondent indicates that he prefers the second logo.

Dynamic survey questions may employ principles of genetic algorithms, as well as other known techniques for adjusting parameters to improve an output. Genetic algorithms are described in “Genetic Programming II”, by John R. Koza, published by The MIT Press, 1994.

It may be desirable to register the response time for each respondent question received, and use that response time as part of the data summarized for the client. For example, in indicating which of two logos is preferred, the client may desire to know whether respondents answered quickly or slowly. Short response times would tend to indicate the comparison was very easy and thus the chosen logo was clearly preferred, while long response times would tend to indicate the comparison was difficult and thus the chosen logo was marginally preferred.

While the present invention has been described in terms of several preferred embodiments, there are many alterations, permutations, and equivalents that may fall within the scope of this invention. It should also be noted that there are many alternative ways of implementing the methods and apparatuses of the present invention. It is therefore intended that the following appended claims be interpreted as including all such alterations, permutations, and equivalents as fall within the true spirit and scope of the present invention.

What is claimed is:

1. A computer system for enhancing a customer list for a targeted marketing campaign, the computer system comprising:
a data storage device comprising: a customer list comprising customer information for a plurality of customers; and a survey results database for storing the results of a survey of each of the plurality of customers;
a multivariate statistical computer model which models a relationship between the customer information and the results of the survey; and
a scoring algorithm configured to generate a score for each of the plurality of customers based on the predictive computer model.

2. The computer system of claim 1, wherein the multivariate statistical computer model employs a multivariate statistical technique in which the results of the survey is a dependent variable and the customer information is a predictive variable.

3. The computer system of claim 1, wherein the multivariate statistical computer model defines a predictive equation which is processed by the scoring algorithm.

4. The computer system of claim 1, wherein the customer information comprises credit card use information.

5. The computer system of claim 1, wherein the results of the survey comprises information regarding purchase intent for a particular product.

6. The computer system of claim 1, further comprising a network device configured to interface with a communications network.

7. The computer system of claim 6, wherein the customer list is received from a client via the communications network.

8. The computer system of claim 7, wherein the scores are provided to the client via the communications network.

9. The computer system of claim 6, wherein the survey is administered to the customers via the communications network.

10. The computer system of claim 1, wherein the scores generated by the scoring algorithm indicate at least one of the following: a propensity to purchase a good or service; a propensity to exhibit a particular attitude; a propensity to have a particular consumer behavior; and a propensity to possess a particular demographic.

11. The computer system of claim 1, wherein the multivariate statistical computer model comprises a plurality of consumer characteristics and a corresponding weight for calculating the score.

12. The computer system of claim 1, wherein the customer list is modified to reflect the scores.

13. The computer system of claim 1, wherein the scores are provided in a sorted list.

14. A method for generating an enhanced customer list for a targeted marketing campaign, the method comprising:
receiving a customer list comprising customer information for a plurality of customers;
surveying each of the plurality of customers based on a market survey to determine survey results;
modeling a relationship between the customer information and the survey results; and
generating a score for each of the plurality of customers based on the predictive computer model.

15. The method of claim 14, wherein the receiving the customer list comprises receiving a data file from a client via a communications network.

16. The method of claim 14, wherein the scores indicate at least one of the following: a propensity to purchase a good or service; a propensity to exhibit a particular attitude; a propensity to have a particular consumer behavior; and a propensity to possess a particular demographic.

17. The method of claim 14, wherein the surveying each of the plurality of customers occurs via a communications network.

18. The method of claim 17, wherein the customer information comprises credit card use information.

19. A computer system for providing a customer list enhancement service to a plurality of clients via a communications network, the computer system comprising:
a controller for interfacing with a communications network, the controller configured to:
receive a customer list from a client via the communications network, the customer list comprising customer information for a plurality of customers;
administer a survey to each of the plurality of customers via the communications network;
a predictive computer model which models a relationship between the customer information and results of the survey; and
a scoring algorithm configured to generate a score for each of the plurality of customers based on the predictive computer model.

20. The computer system of claim 19, wherein the score comprises a probabilistic indicator of a consumer attribute, and the controller is further configured to provide the scores to the client.
